(19) United States
(12) Patent Application Publication
(10) Pub. No.: US 2026/0236225 A1
(43) Pub. Date: Aug. 13, 2026

(54) DYNAMIC FLOATING-POINT PROCESSING

(71) Applicant: Arm Limited, Cambridge (GB)

(72) Inventors: Nigel John Stephens, Cambridge (GR); Jelena Milanovic, Biot (FR); Jayasree Sankaranarayanan, Bangalore (IN)

(73) Assignee: Arm Limited, Cambridge (GB)

(21) Appl. No.: 19/157,502

(22) PCT Filed: Jan. 15, 2024
(86) PCT No.: PCT/GB2024/050090

§ 371 Date: Aug. 18, 2025

(30) Foreign Application Priority Data
Feb. 24, 2023 (IN) 202311012702

(51) Int. Cl. G06F 7/483

(52) U.S. Cl. CPC G06F 7/483

(57) ABSTRACT

A data processing apparatus includes mode circuitry for indicating a first format of a first floating-point parameter and separately indicating a second format of a second floating-point parameter. Floating-point circuitry performs a two-parameter floating-point operation using the first floating-point parameter in the first format and the second floating-point parameter in the second format. At least one of the first format and the second format is dynamically changeable at runtime.

### TECHNICAL FIELD

The present disclosure relates to data processing.

### DESCRIPTION

Floating-point numbers are a way of encoding an approximation of a mathematical real value within a data processing apparatus by using some bits of the number to represent a radix exponent, which indicates the position of the radix point within the integral part of the number, known as the mantissa or significand. The width of the exponent determines the maximum range of representable numbers, while the width of the mantissa determines the maximum precision of each number. 8-bit floating-point numbers have not typically been used for general-purpose data processing because of their limited range and precision but are of interest for neural networks thanks to their larger range and ease of processing relative to the 8-bit integers used in many networks.

### SUMMARY

Viewed from a first example configuration, there is provided data processing apparatus comprising: mode circuitry configured to indicate a first format of a first floating-point parameter and to separately indicate a second format of a second floating-point parameter; and floating-point circuitry configured to perform a two-parameter floating-point operation using the first floating-point parameter in the first format and the second floating-point parameter in the second format, wherein at least one of the first format and the second format is dynamically changeable at runtime.

Viewed from a second example configuration, there is provided a data processing method comprising: indicating a first format of a first floating-point parameter; separately indicating a second format of a second floating-point parameter; and performing a two-parameter floating-point operation using the first floating-point parameter in the first format and the second floating-point parameter in the second format, wherein at least one of the first format and the second format is dynamically changeable at runtime.

Viewed from a third example configuration, there is provided a computer program for controlling a host data processing apparatus to provide an instruction execution environment comprising: mode logic configured to indicate a first format of a first floating-point parameter and to separately indicate a second format of a second floating-point parameter; and floating-point logic configured to perform a two-parameter floating-point operation using the first floating-point parameter in the first format and the second floating-point parameter in the second format, wherein at least one of the first format and the second format is dynamically changeable at runtime.

### BRIEF DESCRIPTION OF THE DRAWINGS

The present invention will be described further, by way of example only, with reference to embodiments thereof as illustrated in the accompanying drawings, in which:

FIG. 1 illustrates a data processing apparatus in accordance with some examples;

FIG. 2 illustrates how the changing format can affect how bits that form an 8-bit floating-point number can lead to different numbers;

FIG. 3 shows the effect of the mode circuitry on different floating-point instructions;

FIG. 4 illustrates a flow chart that shows a method of data processing in accordance with some examples; and

FIG. 5 illustrates a simulator implementation that may be used.

### DESCRIPTION OF EXAMPLE EMBODIMENTS

Before discussing the embodiments with reference to the accompanying figures, the following description of embodiments is provided.

In accordance with some examples, there is provided a data processing apparatus comprising: mode circuitry configured to indicate a first format of a first floating-point parameter and to separately indicate a second format of a second floating-point parameter; and floating-point circuitry configured to perform a two-parameter floating-point operation using the first floating-point parameter in the first format and the second floating-point parameter in the second format, wherein at least one of the first format and the second format is dynamically changeable at runtime.

In these examples, the mode circuitry is able to dynamically control how bits provided to the floating-point circuitry are interpreted. In particular, what the format of the parameters of the floating-point operation are. Here, the term ‘format’ considers how the series of bits are interpreted. For instance, the format might dictate the location of a sign bit, the location of mantissa bits, and the location of exponent bits (and therefore how many bits are used for each component of a floating-point number). For example, in one format, the first bit might be a sign bit whereas in another format, the first bit might be the first bit of a mantissa. The format might indicate that certain parts of the floating-point number are implicit, might dictate the significance of bits (whether earlier bits are more or less significant than later bits of the same component), and so on. Since one or more of the formats are changeable dynamically at runtime (e.g. by changing the configuration of the mode circuitry), the formats can be changed over time. For instance, one instruction might be executed with the formats of the parameters being one combination and another instruction might be executed with the formats of the parameters being a second combination. The format indication is separate, which is to say that each format is specified individually rather than providing one format for all parameters. The floating-point operation could be a conversion (e.g. from another floating-point number or even from a non-floating-point number), a computation, or a combination of the two. In some examples, the floating-point operation may additionally perform non floating-point operations.

In some examples, at least one of the first floating-point parameter and the second floating-point parameter are 8-bit floating-point numbers. Unlike many other types of floating-point numbers (such as half precision 16-bit floating-point numbers or single precision 32-bit floating-point numbers) there is no well-established single definition of what format an 8-bit floating-point number should take. This is in spite of the general agreement that an 8-bit floating-point number would have particular well-defined uses such as in neural networks. Indeed, the limited number of bits available make it significantly harder to produce a single definition of a format of an 8-bit floating-point number because with so few bits available, even a movement of a single bit from a mantissa to an exponent could have a significant effect on the accuracy that can be achieved using such a number and could therefore easily render such numbers practical or impractical for specific applications. By allowing the format of the floating-point number parameters to be changed, the range of applications for which such a data processing apparatus can be used can be expanded.

In some examples, the first format and the second format are chosen from the list comprising: (1-bit sign, 5-bit exponent, and 2-bit mantissa), and (1 bit sign, 4-bit exponent, and 3-4 bit mantissa). An 8-bit floating-point number having four bits for an exponent and three bits for a mantissa (with one bit being used for the sign) can be referred to as E4M3. An 8-bit floating-point number having five bits for an exponent and two bits for a mantissa (and again, one bit for the sign) can be referred to as E5M2. Thus, E5M2 is capable of representing larger (or smaller) numbers, but at a lower precision than E4M3.

In some examples, the first format and the second format are different. For instance, the first format might be E5M2 and the second format might be E4M3. In other embodiments, despite the fact that the mode circuitry provides for the specification of two formats, the two formats are the same.

In some examples, the data processing apparatus comprises: decode circuitry, responsive to a two-parameter floating-point instruction to generate one or more control signals to perform the two-parameter floating-point operation, wherein the two-parameter floating-point instruction comprises a first parameter field configured to indicate the first floating-point parameter and a second parameter field configured to indicate the second floating-point parameter. The instruction's encoding defines a first parameter field and a second parameter field. These could be used to specify a location of the first floating-point parameter and the second floating-point parameter or an actual value of the first floating-point parameter and the second floating-point parameter. During decoding, the instruction is used to generate a series of control signals, which are used to influence the behaviour of the floating-point circuitry for instance, as well as gathering the value(s) to be operated on.

In some examples, the two-parameter floating-point instruction does not specify the first format or the second format. That is, the behaviour of the floating-point circuitry in interpreting bits of the parameters is dictated by the mode circuitry. Consequently, the same instruction executed twice will have different behaviour if the mode circuitry's value is changed between the executions.

In some examples, the second floating-point parameter is an input parameter; and the two-parameter floating-point instruction comprises an input parameter selection field configured to indicate whether the input parameter is in the first format or is in the second format. In these examples, the two-parameter floating-point instruction may take a single input. The input parameter selection field can then be used to specify which of the two possible input formats specified in the mode circuitry should be used to interpret that input. That is, whether the input parameter should be interpreted according to the first format or the second format.

In some examples, the first floating-point parameter is an output of the two-parameter floating-point operation. In some of these examples, one of the parameters is an output parameter that indicates a location to which a result of the floating-point operation should be stored. Note that this does not necessitate that the parameter that is placed in the first position of the instruction is an output of the two-parameter floating-point operation. Indeed, an output parameter could be placed in any position of an instruction. For instance, the second parameter could identify a location into which a result of the processing of the floating-point operation is to be stored (either a memory address or a location). The format associated with this parameter can be used to indicate the output format.

In some examples, the second floating-point parameter is an output of the two-parameter floating-point operation.

In some examples, at least one of the first floating-point parameter and the second floating-point parameter is an input of the two-parameter floating-point operation. In some examples, both the first floating-point parameter and the second floating-point parameter are inputs of the two-parameter floating-point operation.

In some examples, the mode circuitry is configured to separately indicate a third format of an output parameter. The mode circuitry can be used to separately indicate what the third format is. In some examples, the floating-point circuitry is configured to perform the floating-point operation using the first floating-point parameter in the first format, the second floating-point parameter in the second format and to output a result of the floating-point operation in the third format.

In some examples, each of the indications of the first format and the second format is three bits. A register can therefore be used to indicate what each of the different formats are. In these examples, three bits are used for each format e.g. three bits for the first parameter, a further three bits for the second parameter and a still further three bits for the third format if one is provided (e.g. for the output parameter of conversion instructions with an 8-bit floating point result). Simply because the mode circuitry makes it possible to specify up to three different formats does not mean that all instructions might make use of them. As previously explained some instruction encodings may include a bit (or bits) that indicates which of the three formats should be used.

In some examples, the mode circuitry is configured to indicate one or more scaling factors; the one or more scaling factors are used to scale outputs from the two-parameter floating-point operation; and the one or more scaling factors are used to scale inputs to the two-parameter floating-point operation. As described above, an 8-bit floating-point number contains very few bits and therefore is limited in terms of the range of numbers that can be represented (even in the case of E5M2). The scaling factor can therefore be used to increase the range of numbers that can be represented by the floating-point parameters by providing an automatic scaling up and down of inputs and outputs of instructions that access the mode circuitry.

In some examples, the one or more scaling factors comprise an input scaling factor; and in response to the two-parameter floating-point operation being a conversion operation generated from a conversion instruction, the inputs to the two-parameter floating-point operation are scaled in accordance with the input scaling factor.

In some examples, the one or more scaling factors comprise a output scaling factor; and in response to the two-parameter floating-point operation being a multiplication operation generated from a multiplication instruction, the outputs from the two-parameter floating-point operation are scaled in accordance with the output scaling factor. This makes it possible, for instance, to treat the result of an operation (e.g. the multiplication of two 8-bit floating-point numbers) as significantly smaller than it would ordinarily be. Such a situation can arise often in neural network processing where a trained network has been generated using floating-point numbers than are significantly smaller than can be represented by an 8-bit floating-point number. By providing a scaling factor, it is possible to increase this range and represent very small numbers. Note that the result of a multiplication can be scaled by providing only a single scaling factor since adjustments to the scaling can be achieved by modifying the product's exponent, whereas this is not true of addition, which would require one scaling factor per parameter.

In some examples, the one or more scaling factors are powers of two. Scaling floating-point numbers by a power of two is possible by simply performing an addition to or subtraction from the radix two exponent of the floating-point number. Hence the floating-point circuitry can process a much larger or smaller number (as indicated by the scaling factor) by adjusting the exponent as it is input to or output from the floating-point circuitry.

Particular embodiments will now be described with reference to the figures.

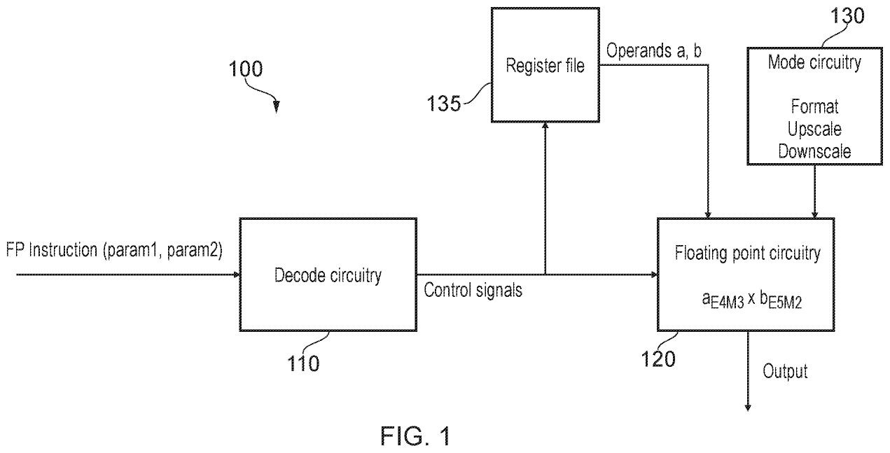

FIG. 1 illustrates a data processing apparatus 100 in accordance with some examples. A floating-point instruction with two parameters is received by decode circuitry 110, which decodes the instruction into one or more control signals. The two parameters may, in practice, be the identity of two registers in a register file 135 that contain floating-point numbers. The parameters could also be memory locations where the floating-point numbers are stored, or could be floating-point numbers themselves, or the parameters could be a mixture of these (or other) possibilities. In any event, the instruction is such that it indicates that a floating-point operation is to be performed using two floating-point numbers. Also in this example, the floating-point numbers are 8-bit numbers. As previously explained there is no singular definition of the format of an 8-bit floating-point number. The small number of bits and the multiple pieces of information that are to be described in a floating-point number mean that different applications will have different requirements as to whether bits are used to express the mantissa or the exponent.

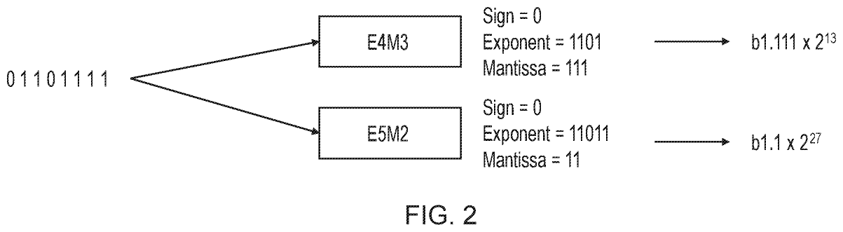

In these examples, therefore, mode circuitry 130 is provided that stores an indication of the current format that is to be applied to an 8-bit floating-point number. That is, the same floating-point instruction will be decoded by the decode circuitry 110 in the same way each time. However, if the format indicated in the mode circuitry 130 changes between executions of the same instruction then the actual numbers that are part of the operation will change, because the interpretation of the bits that make up the 8-bit floating-point number will differ. This is illustrated in more detail with respect to FIG. 2.

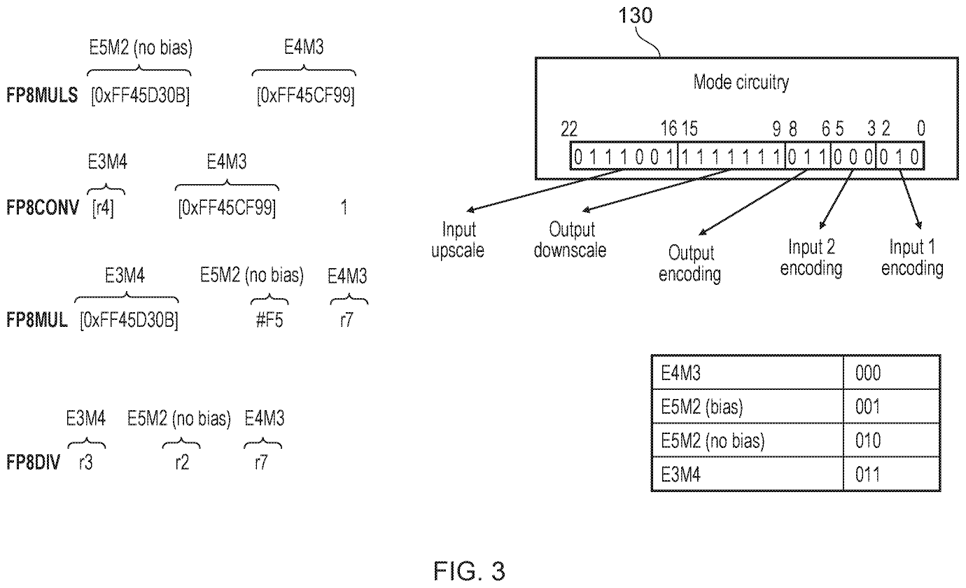

The mode circuitry 130 may take the format of a register in which a number of bits indicate the format that is to be applied at any time. It may also include input and output scaling parameters. Each of these options is illustrated in more detail with respect to FIG. 3.

FIG. 2 illustrates how the changing format can affect how bits that form an 8-bit floating-point number can lead to different numbers. In each case, the actual bits that make up the 8-bit floating-point number are ‘01101111’. When the format is E4M3, the first bit (0) is used as the sign, which for the sake of argument, we will interpret as being ‘positive’. The next four bits (1101) are used for the exponent, which is 13 in decimal. Finally, the next three bits (111) are used for the mantissa. Floating-point numbers typically start with an implicit ‘1.’ and so the full significand would be 1.111 (1+0.5+0.25+0.125=1.875). Thus, in the E4M3 mode of interpretation, the bits ‘01101111’ might be interpreted as 1.875×2¹³.

In a second mode, the same bits ‘01101111’ are interpreted as an E5M2 format number. Again, the first bit (0) is used for the sign, which we are again interpreting as positive. This time, the next five bits (11011) are used for the exponent, which is 27 in decimal. Finally, the next two bits (11) are used for the mantissa. This translates to 1.11 (1+0.5+0.25=1.75). Thus, in the E5M2 mode of interpretation, the bits ‘01101111’ might be interpreted as 1.75×2²⁷—a very different number to 1.875×2¹³.

Note that the above examples omit any concept of exponent bias and for the sake of convenience have assumed that the mantissa in positive. In practice, the exponent may be biased (e.g. when the bits ‘0000’ suggest that an exponent should be 0 this might equate to an exponent of −7). Fixed biases may form part of the format of a floating-point number. As well as the size of the exponent and mantissa, and the exponent bias, the format could also determine whether and how special values are encoded and interpreted—for example Infinity, Not-a-Number (NaN), Minus 0.0—as well the minimum and maximum representable floating-point values.

It will be appreciated that many of the above format changes can be handled in floating-point circuitry by controlling the wiring of bits. For instance, the difference between E4M3 and E3M4 simply controls whether the fourth bit is an exponent or a mantissa. This can therefore be achieved by wiring bit four to both an exponent collector and a mantissa collector and allowing the bit to be passed into either structure depending on the mode circuitry 130. Similarly, a bias (and possibly encodings of special values) may either be provided (or not) depending on the value of the mode circuitry 130.

FIG. 3 shows the effect of the mode circuitry 130 on different floating-point instructions. These instructions are, of course, merely given as examples. In this example, the mode circuitry 130 takes the form of a register. The first three bits ([2:0]) indicate the format of a first input parameter. The next three bits ([5:3]) indicate the format of a second input parameter. The next three bits ([8:6]) indicate the format of an output parameter. The next seven bits ([15:9]) indicate a scale factor that is to be applied to the output of a multiply operation. Finally, the next seven bits ([22:16]) indicate a scale factor that is to be applied to the input of conversion operations from higher-precision formats. Below, it is illustrated how these encodings affect the instructions.

A first example instruction FP8MULS multiplies two 8-bit floating-point numbers and stores the result on the stack. Here, both input numbers are in memory at addresses specified in the instruction. Since there are two inputs, the first input follows the encoding specified by bits [2:0] in the mode circuitry 130 and the second input follows the encoding specified by bits [5:3] in the mode circuitry 130. In this example, therefore, the first input parameter is interpreted as an E5M2 with no bias, and the second input is interpreted as an E4M3.

A next example instruction FP8CONV takes a floating-point number stored in one format and stores it back in another format. In this example, the input is at a memory address (0xFF45CF99) specified in the instruction and the resulting output is stored at a memory address stored in a register r4. Here, there is only one input parameter and so a bit (‘1’ in this case) is used to indicate whether the format specified by the input 1 encoding or the input 2 encoding should be used to interpret the input. Here, the bit (1) indicates that the format is as per the input 2 encoding (‘000’), which corresponds to E4M3. Thus, the input will be interpreted as an E4M3. The remaining parameter is an output parameter, and specifies that the resulting converted value should be stored in a memory address specified by register r4. It is stored in a format corresponding with the output format, which in this case is E3M4.

A third example instruction FP8MUL multiplies two 8-bit floating-point numbers and stores the result in a specified location. Here, the first floating-point number is an immediate value within the instruction (F5—11110101). This parameter follows the input 1 encoding (010) and is therefore interpreted as an E5M2 with no bias. The second parameter specifies that the floating-point value is stored in a register r7. Its encoding follows the input 2 encoding (000) and is therefore interpreted as an E4M3 value. Finally, the output is stored in a location in memory (0xFF45D30B). It follows the output format and so is encoded as an E3M4 value.

A fourth example instruction FP8DIV performs a division between two 8-bit floating-point numbers and stores the result in a specified location. In this example, each of the parameters specifies a register. The first input parameter is the register r2 and so the first input to the operation is stored in register r2. The input is formatted in the input 1 encoding and is therefore interpreted as an E5M2 value with no bias. The second input parameter specifies the register r7 and so the value of the operation is stored there. It follows the input 2 encoding and is therefore interpreted as an E4M3 value. Finally, the output is to be stored in a register r3 and the output is in the format specified by the output format (an E3M4 value).

Another example instruction may be a multiply add instruction which reads two 8-bit floating-point inputs, multiplies them, then adds the product to an 16-bit floating-point or 32-bit floating-point input, and writes the final 16-bit floating-point or 32-bit floating-point result to the output location. An alternative would be an accumulating variant where the same location is used as both the 32-bit floating-point/16-bit floating-point input and 32-bit floating-point/16-bit floating-point output. Note that although this is arguably a four-parameter operation, there are not more than two 8-bit floating-point input parameters: the other input and output are defined by the instruction's encoding (not the mode circuitry 130) as fixed-format single precision or half precision.

As already explained, these instructions are merely examples and there are a number of ways in which the parameters of an instruction can be used to obtain the inputs to the floating-point operation. For instance, in some examples, every input and output parameter might be a register. In some other examples, every input and output might be a memory address. In still other examples, there might be a mixed use of registers, memory addresses, and immediate values. Some architectures might support all such configurations whereas other architectures might only support some configurations.

In this example, the mode circuitry 130 also provides the opportunity for parameters to be upscaled or downscaled. For instance, in this example, the mode circuitry 130 indicates that the output of a multiplication should be downscaled by 1111111 (2¹²⁷) in order to output a 32-bit single-precision or 16-bit half-precision result. In this case, the output value can be scaled by simply subtracting 127 from the exponent of the output. In this example, since the output is not an 8-bit floating point number, the output format provided in the mode circuitry 130 is ignored (although the input formats will still be observed since the inputs are 8-bit floating-point numbers).

In another example, scaling is performed during conversion of a 32-bit or 16-bit input to 8-bit floating-point. For example, an instruction FCVT32TO8 can take a 32-bit floating point number as an input, scale it into the FP8 range, and then convert the result into an FP8 format output (using the output format parameter of the mode circuitry 130 to specify the format of the FP8 output). In this example, the mode circuitry 130 indicates that the input value should be upscaled by 0111001 (2⁵⁷) by simply adding 57 to its exponent. Again, since the input is a 32-bit floating-point number, the input format is disregarded.

The upscaling and downscaling allows a wider range of floating-point numbers to be operated on using 8-bit floating-point representations.

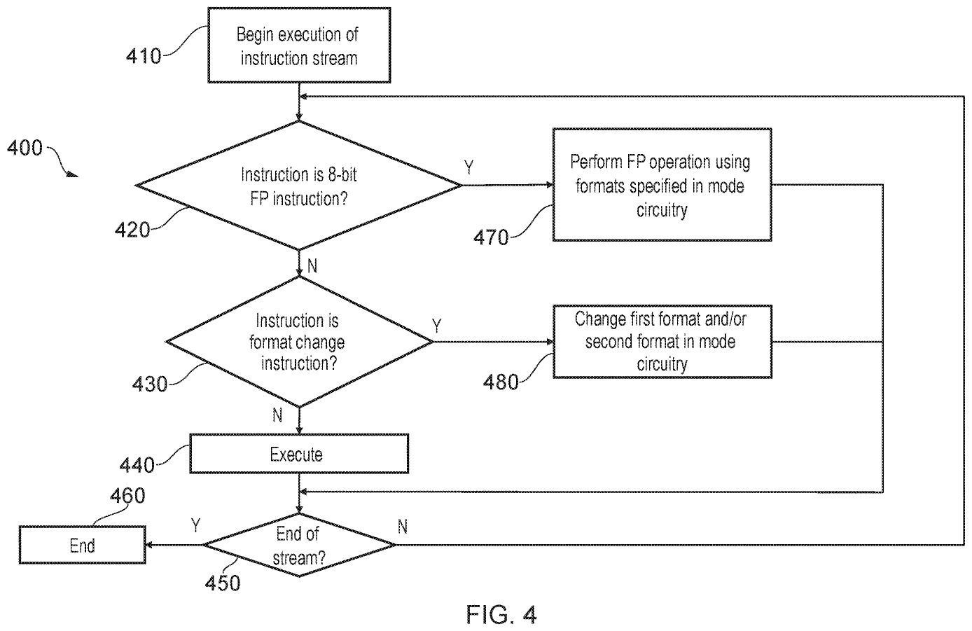

FIG. 4 illustrates a flow chart 400 that shows a method of data processing in accordance with some examples. The process begins at step 410 where execution of an instruction stream begins. Then, at step 420, if the instruction is an 8-bit floating-point instruction then the floating-point operation is performed using the values specified in the mode circuitry 130 to interpret the inputs and outputs. The process then proceeds to step 450. Otherwise, if the instruction is not an 8-bit floating-point instruction, then at step 430 it is determined if the instruction is a format change instruction. A format change instruction is one example way in which the formats specified in the mode circuitry 130 can be altered at runtime. Such an instruction might, for instance, specify a new value that is to be stored in the mode circuitry 130. If so, then at step 480 the first and/or second formats specified in the mode circuitry 130 are changed and the process proceeds to step 450. Otherwise, at step 440, the instruction is executed as usual and the process proceeds to step 450. At step 450, it is determined whether the end of the instruction stream has been reached. If so, then at step 460, the process ends. Otherwise the process returns to step 420.

As a consequence of the above, it can be seen that the way in which 8-bit floating-point numbers are interpreted can be changed dynamically at runtime (e.g. partway through a stream of instructions).

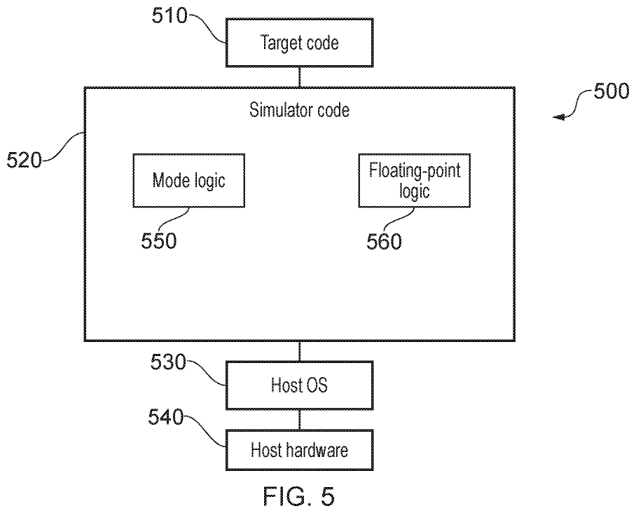

FIG. 5 illustrates a simulator implementation 500 that may be used. Whilst the earlier described embodiments implement the present invention in terms of apparatus and methods for operating specific processing hardware supporting the techniques concerned, it is also possible to provide an instruction execution environment in accordance with the embodiments described herein which is implemented through the use of a computer program. Such computer programs are often referred to as simulators, insofar as they provide a software based implementation of a hardware architecture. Varieties of simulator computer programs include emulators, virtual machines, models, and binary translators, including dynamic binary translators. Typically, a simulator implementation may run on a host processor 540, optionally running a host operating system 530, supporting the simulator program 520. In some arrangements, there may be multiple layers of simulation between the hardware and the provided instruction execution environment, and/or multiple distinct instruction execution environments provided on the same host processor. Historically, powerful processors have been required to provide simulator implementations which execute at a reasonable speed, but such an approach may be justified in certain circumstances, such as when there is a desire to run code native to another processor for compatibility or re-use reasons. For example, the simulator implementation may provide an instruction execution environment with additional functionality which is not supported by the host processor hardware, or provide an instruction execution environment typically associated with a different hardware architecture. An overview of simulation is given in “Some Efficient Architecture Simulation Techniques”, Robert Bedichek, Winter 1990 USENIX Conference, Pages 53-63.

To the extent that examples have previously been described with reference to particular hardware constructs or features, in a simulated example, equivalent functionality may be provided by suitable software constructs or features. For example, particular circuitry may be implemented in a simulated example as computer program logic. Similarly, memory hardware, such as a register or cache, may be implemented in a simulated example as a software data structure. In arrangements where one or more of the hardware elements referenced in the previously described examples are present on the host hardware (for example, host processor 540), some simulated embodiments may make use of the host hardware, where suitable.

The simulator program 520 may be stored on a computer-readable storage medium (which may be a non-transitory medium), and provides a program interface (instruction execution environment) to the target code 510 (which may include applications, operating systems and a hypervisor) which is the same as the interface of the hardware architecture being modelled by the simulator program 520. Thus, the program instructions of the target code 510 may be executed from within the instruction execution environment using the simulator program 520, so that a host computer 540 which does not actually have the hardware features of the apparatus 100 discussed above can emulate these features.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, System Verilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and System Verilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes, additions and modifications can be effected therein by one skilled in the art without departing from the scope and spirit of the invention as defined by the appended claims. For example, various combinations of the features of the dependent claims could be made with the features of the independent claims without departing from the scope of the present invention.

1. A data processing apparatus comprising:
mode circuitry configured to indicate a first format of a first floating-point parameter and to separately indicate a second format of a second floating-point parameter; and
floating-point circuitry configured to perform a two-parameter floating-point operation using the first floating-point parameter in the first format and the second floating-point parameter in the second format, wherein
at least one of the first format and the second format is dynamically changeable at runtime.

2. The data processing apparatus according to claim 1, wherein
at least one of the first floating-point parameter and the second floating-point parameter are 8-bit floating-point numbers.

3. The data processing apparatus according to claim 1, wherein
the first format and the second format are chosen from the list comprising:
(1-bit sign, 5-bit exponent, and 2-bit mantissa), and
(1 bit sign, 4-bit exponent, and 3-bit mantissa).

4. The data processing apparatus according to claim 1, wherein
the first format and the second format are different.

5. The data processing apparatus according to claim 1, comprising:
decode circuitry, responsive to a two-parameter floating-point instruction to generate one or more control signals to perform the two-parameter floating-point operation, wherein
the two-parameter floating-point instruction comprises a first parameter field configured to indicate the first floating-point parameter and a second parameter field configured to indicate the second floating-point parameter.

6. The data processing apparatus according to claim 5, wherein
the two-parameter floating-point instruction does not specify the first format or the second format.

7. The data processing apparatus according to claim 5, wherein
the second floating-point parameter is an input parameter; and
the two-parameter floating-point instruction comprises an input parameter selection field configured to indicate whether the input parameter is in the first format or is in the second format.

8. The data processing apparatus according to claim 1, wherein
the first floating-point parameter is an output of the two-parameter floating-point operation.

9. The data processing apparatus according to claim 1, wherein
the second floating-point parameter is an output of the two-parameter floating-point operation.

10. The data processing apparatus according to claim 1, wherein
at least one of the first floating-point parameter and the second floating-point parameter is an input of the two-parameter floating-point operation.

11. The data processing apparatus according to claim 1, wherein
the mode circuitry is configured to separately indicate a third format of an output parameter.

12. The data processing apparatus according to claim 1, wherein
the mode circuitry comprises a register for storing indications of the first format and the second format.

13. The data processing apparatus according to claim 12, wherein
each of the indications of the first format and the second format is three bits.

14. The data processing apparatus according to claim 1, wherein
the mode circuitry is configured to indicate one or more scaling factors;
the one or more scaling factors are used to scale outputs from the two-parameter floating-point operation; and
the one or more scaling factors are used to scale inputs to the two-parameter floating-point operation.

15. The data processing apparatus according to claim 14, wherein
the one or more scaling factors comprise an input scaling factor; and
in response to the two-parameter floating-point operation being a conversion operation generated from a conversion instruction, the inputs to the two-parameter floating-point operation are scaled in accordance with the input scaling factor.

16. The data processing apparatus according to claim 13, wherein
the one or more scaling factors comprise an output scaling factor; and
in response to the two-parameter floating-point operation being a multiplication operation generated from a multiplication instruction, the outputs from the two-parameter floating-point operation are scaled in accordance with an output scaling factor.

17. The data processing apparatus according to claim 13, wherein
the one or more scaling factors are powers of two.

18. A data processing method comprising:
indicating a first format of a first floating-point parameter;
separately indicating a second format of a second floating-point parameter; and
performing a two-parameter floating-point operation using the first floating-point parameter in the first format and the second floating-point parameter in the second format, wherein
at least one of the first format and the second format is dynamically changeable at runtime.

19. A computer program for controlling a host data processing apparatus to provide an instruction execution environment comprising:
mode logic configured to indicate a first format of a first floating-point parameter and to separately indicate a second format of a second floating-point parameter; and
floating-point logic configured to perform a two-parameter floating-point operation using the first floating-point parameter in the first format and the second floating-point parameter in the second format, wherein
at least one of the first format and the second format is dynamically changeable at runtime.

20. A non-transitory computer-readable medium to store computer-readable code for fabrication of the data processing apparatus according to claim 1.
